(19) United States
(12) Patent Application Publication
(10) Pub. No.: US 2025/0209657 A1
(43) Pub. Date: Jun. 26, 2025

(54) METHOD AND ELECTRONIC DEVICE FOR TRACKING OBJECT

(71) Applicant: SAMSUNG ELECTRONICS CO., LTD., Suwon-si (KR)

(72) Inventor: Jaeyong JU, Suwon-si (KR)

(73) Assignee: SAMSUNG ELECTRONICS CO., LTD., Suwon-si (KR)

(21) Appl. No.: 19/076,426

(22) Filed: Mar. 11, 2025

Related U.S. Application Data
(63) Continuation of application No. PCT/KR2023/009035, filed on Jun. 28, 2023.

(30) Foreign Application Priority Data
Sep. 29, 2022 (KR) 10-2022-0124702
Jan. 3, 2023 (KR) 10-2023-0000901

(51) Int. Cl. G06T 7/70; G06V 10/40; G06V 10/764

(52) U.S. Cl. CPC G06T 7/70; G06V 10/40; G06V 10/764

(57) ABSTRACT

A method of tracking at least one object, includes: obtaining an image; extracting, from the image, a feature map for performing a plurality of tasks related to object tracking; extracting, by using the extracted feature map, location information indicating a location of the at least one object, an identification feature for identifying the at least one object, and a body orientation angle at which a body of the at least one object is oriented; and tracking the at least one object, based on the location information, the identification feature, and the body orientation angle of the at least one object.

### CROSS-REFERENCE TO RELATED APPLICATIONS

This application is a by-pass continuation application of International Application No. PCT/KR2023/009035, filed on Jun. 28, 2023, which is based on and claims priority to Korean Patent Application Nos. 10-2022-0124702, filed on Sep. 29, 2022, and 10-2023-0000901, filed on Jan. 3, 2023, in the Korean Intellectual Property Office, the disclosures of which are incorporated by reference herein their entireties.

### BACKGROUND

### 1. Field

The disclosure relates to a method of tracking an object, an electronic device for tracking an object, and a computer-readable recording medium having recorded thereon a program for performing, on a computer, the method of tracking an object.

### 2. Description of Related Art

In the field of computer vision, research has been actively conducted on object tracking technology that enables detecting at least one object in an image or image sequence obtained by an electronic device and tracking trajectories of the respective at least one object simultaneously. In order to track at least two objects simultaneously, it is necessary to perform a first process of detecting a first object and a second process of matching the detected first object with a second object that has been previously tracked.

During object tracking, occlusions (objects may disappear and then reappear in the camera's field of view) may occur, such as first occlusion that occurs when a part of an object obscures another part of the object, second occlusion that occurs between objects, and third occlusion that occurs due to structures in the background.

### SUMMARY

According to an aspect of the disclosure, a method of tracking at least one object, includes: obtaining an image; extracting, from the image, a feature map for performing a plurality of tasks related to object tracking; extracting, by using the extracted feature map, location information indicating a location of the at least one object, an identification feature for identifying the at least one object, and a body orientation angle at which a body of the at least one object is oriented; and tracking the at least one object, based on the location information, the identification feature, and the body orientation angle of the at least one object.

According to an aspect of the disclosure, an electronic device configured to track at least one object, includes: a communication interface; memory storing at least one instruction; and at least one processor operatively connected with the memory, wherein the at least one processor is configured to execute the at least one instruction to: obtain an image; extract, from the image, a feature map for performing a plurality of tasks related to object tracking; extract, by using the extracted feature map, location information indicating a location of the at least one object, an identification feature for identifying the at least one object, and a body orientation angle at which a body of the at least one object is oriented; and track the at least one object, based on the location information, the identification feature, and the body orientation angle of the at least one object.

According to an aspect of the disclosure, a non-transitory computer-readable recording medium having recorded thereon a program for performing, on a computer, a method of tracking at least one object, which includes: obtaining an image; extracting, from the image, a feature map for performing a plurality of tasks related to object tracking; extracting, by using the extracted feature map, location information indicating a location of the at least one object, an identification feature for identifying the at least one object, and a body orientation angle at which a body of the at least one object is oriented; and tracking the at least one object, based on the location information, the identification feature, and the body orientation angle of the at least one object.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a method of tracking an object by an electronic device using tracking information of the object, according to an embodiment of the disclosure;

FIG. 2 illustrates a method of tracking an object by an electronic device, according to an embodiment of the disclosure;

FIG. 3 illustrates a process of tracking an object by using an object tracking model, according to an embodiment of the disclosure;

FIG. 4 illustrates an example operation of training image data of an object tracking model according to an embodiment of the disclosure;

FIG. 5A illustrates a method of extracting location information, an identification feature, and a body orientation angle of an object by using each head of an object tracking model, according to an embodiment of the disclosure;

FIG. 5B illustrates a method of extracting location information of an object by using a detection head of an object tracking model, according to an embodiment of the disclosure;

FIG. 6 illustrates object detection information and object tracking information according to an embodiment of the disclosure;

FIG. 7 illustrates a data association process according to an embodiment of the disclosure;

FIG. 8A illustrates a first data association process according to an embodiment of the disclosure;

FIG. 8B illustrates an example operation of a first data association process according to an embodiment of the disclosure;

FIG. 9 illustrates a second data association process according to an embodiment of the disclosure;

FIG. 10 illustrates a third data association process according to an embodiment of the disclosure;

FIG. 11A illustrates a tracking information management process according to an embodiment of the disclosure;

FIG. 11B illustrates a process of updating tracking information of an object, according to an embodiment of the disclosure;

FIG. 12A illustrates a process of updating a tracking state of an object, according to an embodiment of the disclosure;

FIG. 12B illustrates a process of updating a tracking state of an object, according to an embodiment of the disclosure;

FIG. 13 illustrates a configuration of an electronic device according to an embodiment of the disclosure; and

FIG. 14 illustrates a configuration of an electronic device according to an embodiment of the disclosure.

### DETAILED DESCRIPTION

In the disclosure, the expression “at least one of a, b, or c” can refer to “a”, “b”, “c”, “a and b”, “a and c”, “b and c”, “all of a, b and c”, or variations thereof.

The terms used in the disclosure are selected from commonly used terms as much as possible while considering the functions thereof in the disclosure, but these may vary depending on the intention of engineers working in the field, precedents, the emergence of new technologies, etc. In addition, in certain cases, there are terms arbitrarily selected by the applicant, and in such cases, the meanings thereof will be described in detail in the relevant description section. Therefore, the terms used in the disclosure should be defined based on the meaning of the terms and the overall contents of the disclosure, rather than simply the names of the terms.

A singular expression may include a plural expression unless the context clearly indicates otherwise. Terms used herein, including technical or scientific terms, may have the same meaning as commonly understood by one of ordinary skill in the art described herein. Additionally, terms including ordinal numbers, such as “first” or “second”, used herein may be used to describe various components, but the components should not be limited by the terms. The above terms are used solely to distinguish one component from another component.

When a part of the specification is described to “include” a component, this does not mean that it excludes other components, but rather that it may include other components, unless otherwise stated. In addition, terms such as “unit”, “module”, etc., described herein mean a unit that processes at least one function or operation, which may be implemented by hardware or software, or by a combination of hardware and software.

The artificial intelligence-related functions according to the disclosure are operated through a processor and memory. The processor may consist of one or more processors. In this case, the one or more processors may be a general-purpose processor such as a central processing unit (CPU), access point (AP), or digital signal processor (DSP), a graphics-only processor such as a graphic processing unit (GPU) or vision processing unit (VPU), or an artificial intelligence-only processor such as a neural processing unit (NPU). The one or more processors are controlled to process input data according to predefined operation rules or artificial intelligence models stored in the memory. Alternatively, when the one or more processors are artificial intelligence-specific processors, the artificial intelligence-specific processors may be designed with a hardware structure specialized for processing a specific artificial intelligence model.

The predefined operation rules or artificial intelligence models are characterized by being created through learning. Here, being created through learning means that a basic artificial intelligence model is trained by using a large amount of learning data according to a learning algorithm, thereby creating a predefined operation rule or artificial intelligence model set to perform a desired characteristic (or purpose). Such learning may be performed on the device itself on which the artificial intelligence according to the disclosure is performed, or may be performed through a separate server and/or system. Examples of the learning algorithms include, but are not limited to, supervised learning, unsupervised learning, semi-supervised learning, or reinforcement learning.

The artificial intelligence model may include a plurality of neural network layers. Each of the plurality of neural network layers has multiple weight values, and performs neural network operations through operations between the operation results of the previous layer and the plurality of weight values. The plurality of weights of the plurality of neural network layers may be optimized by the learning results of the artificial intelligence model. For example, the plurality of weights may be updated so that a loss value or cost value obtained from the artificial intelligence model is reduced or minimized during the learning process. For example, the artificial neural network may include a deep neural network (DNN), a convolutional neural network (CNN), a recurrent neural network (RNN), a restricted Boltzmann machine (RBM), a deep belief network (DBN), a bidirectional recurrent deep neural network (BRDNN), or deep Q-networks. But, the disclosure is not limited to the examples described above.

Below, with reference to the attached drawings, embodiments of the disclosure are described in detail so that a person skilled in the art can easily implement the disclosure. However, the disclosure may be implemented in many different forms and is not limited to the embodiments described herein. In addition, in order to clearly explain the disclosure in the drawings, parts that are not related to the description are omitted, and similar parts are given similar drawing reference numerals throughout the specification. In addition, the drawing symbols used in each drawing are only intended to describe each drawing, and different drawing symbols used in different drawings are not intended to indicate different elements.

The disclosure will be described below in detail with reference to the attached drawings.

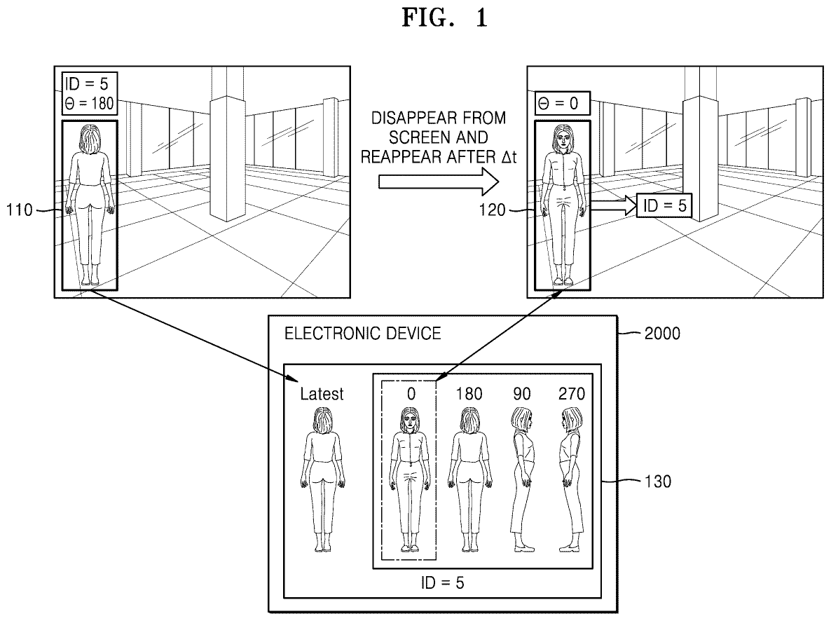

FIG. 1 illustrates a method of tracking an object by an electronic device using tracking information of the object, according to an embodiment of the disclosure.

Referring to FIG. 1, an electronic device 2000 according to an embodiment of the disclosure may track at least one object by using tracking information of the object. In an embodiment, tracking an object may mean that the electronic device 2000 obtains images in real time and detects the object from the obtained images to track a trajectory of the object. For example, the electronic device 2000 may obtain images in real time and detect the object for each frame to track the trajectory of the object. Acquisition times of the respective images may be recorded in the electronic device 2000 on a frame-by-frame basis. For example, each of the images may include a timestamp, and the electronic device 2000 may record the acquisition time of the image based on the timestamp. According to an embodiment, when a plurality of objects are detected in the images obtained in real time, the electronic device 2000 may track the trajectories of the respective objects simultaneously. In this case, the electronic device 2000 may match the detected objects with objects that have been previously tracked, and update tracking information of the objects.

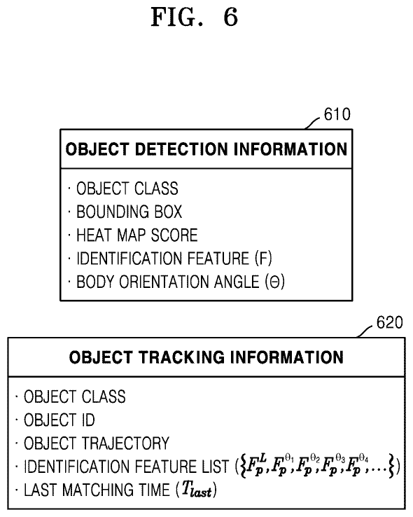

In an embodiment, the tracking information of the object may include at least one of an object class, an ID of the object, a trajectory of the object, an identification feature list of the object, and the last matching time of the object. In an embodiment, the last matching time of the object may be or correspond to an acquisition time of an image in which the corresponding object was last matched with the objects that have been tracked. A detailed description of information included in the tracking information of the object is described below with reference to FIG. 6. The electronic device 2000 may store a tracking database in a memory. The tracking database according to an embodiment may include tracking information of at least one object being tracked by the electronic device 2000.

The object according to an embodiment may be an object having identification features that are distinguished according to a body orientation thereof. For example, the object class may include, but are not limited to, person, vehicle, and animal. For example, when the object class is a person, the front, side, and back views of the person are each distinct, and accordingly, identification features for the front, side, and back views may also be distinct.

In an embodiment, the identification feature may be or correspond to a feature vector for identifying each of the objects within the same class. For example, the electronic device 2000 may detect objects from the images obtained in real time and extract identification features for the detected objects. In this case, identification features for the same object that are extracted from the images by the electronic device 2000 may have high similarity. For example, the identification features for the same object may have cosine similarities therebetween close to 1. On the other hand, identification features for different objects may have low similarity.

Referring to FIG. 1, the electronic device 2000 may detect a first object 110 having an ID of 5. The electronic device 2000 according to an embodiment may identify the first object 110 by using an identification feature list 130 of the first object 110 included in tracking information of the first object 110. In an embodiment, the identification feature list 130 may be or correspond to a list including the latest identification feature of the object and at least one identification feature of the object corresponding to respective representative angles of body orientation. In an embodiment, the representative angles may be or correspond to angles having a predetermined angle interval set for extracting body orientation angles in a classification manner during object detection. For example, when the electronic device 2000 classifies the body orientation angle into ten angles, the representative angles in the body orientation may be set at intervals of 36 degrees. Below, for convenience of descriptions, a case is described as an example in which the electronic device 2000 classifies the body orientation angle into four angles, and the representative angles of body orientation are set to 0 degrees, 90 degrees, 180 degrees, and 270 degrees.

For example, the identification feature list may include all identification features respectively corresponding to the representative angles, or may include only some of the identification features respectively corresponding to the representative angles. When the first object 110 having a body orientation angle of 90 degrees is not detected while the first object 110 is tracked by the electronic device 2000, the identification feature list 130 of the first object 110 may not include the identification feature corresponding to 90 degrees. However, when the first object 110 having a body orientation angle of 90 degrees is detected at a later time, the electronic device 2000 may update the identification feature corresponding to 90 degrees within the identification feature list 130 of the first object 110 by using the extracted identification feature.

In an embodiment, when detecting the first object 110, the electronic device 2000 may detect a body orientation angle of the first object 110. For example, in the case of the first object 110 shown in FIG. 1, the body orientation angle may be detected as 180 degrees. By using the extracted identification feature, the electronic device 2000 according to an embodiment may update the latest identification feature and the identification feature corresponding the detected body orientation angle of the first object 110 within the identification feature list 130 of the first object 110. For example, when the body orientation angle of the first object 110 is detected as 180 degrees, the electronic device 2000 may update, by using the extracted identification feature, the latest identification feature and the identification feature corresponding to 180 degrees of the first object 110 within the identification feature list 130 of the first object 110.

According to an embodiment, the first object 110 may disappear from the screen after being detected by the electronic device 2000 in the obtained image. The first object 110 may disappear from the screen and reappear on the screen after a certain period of time. When the first object 110 reappears on the screen, the first object 110 may reappear with a body orientation at an angle different from the body orientation angle of the first object 110 at the last detection time. When the body orientation of the first object 110 changes, the appearance of the first object 110 may change. If the body orientation of the first object 110 is not considered, the appearance changes even though they are the same object. Accordingly, similarity between an identification feature of the first object 110 extracted from the obtained image and an identification feature of the first object 110 at the last detection time may be low, and there may be difficulty in tracking the object.

The electronic device 2000 according to an embodiment may detect a second object 120. In this case, the electronic device 2000 may detect a body orientation angle of the second object 120. For example, in the case of the second object 120 shown in FIG. 1, the body orientation angle thereof may be detected as 0 degrees. The electronic device 2000 may compare identification features corresponding to 0 degrees within an identification feature list included in each tracking information of objects being tracked, with the extracted identification feature of the second object 120. When the extracted identification feature of the second object 120 has the highest similarity to the identification feature corresponding to 0 degrees within the identification feature list 130 of the first object 110, the electronic device 2000 may determine the second object 120 as the first object 110 and update the tracking information of the first object 110. For example, the electronic device 2000 the latest identification feature and the identification feature corresponding to 0 degrees within the identification feature list 130 of the first object 110 by using the identification feature extracted from the obtained image.

As described above, when identification features according to a body orientation angle are stored for each object, and identification features corresponding to the same body orientation angle are compared when tracking an object, various effects including an effect of increasing the identification rate of the object may be achieved. Below, a method of tracking an object by the electronic device 2000 is described in detail.

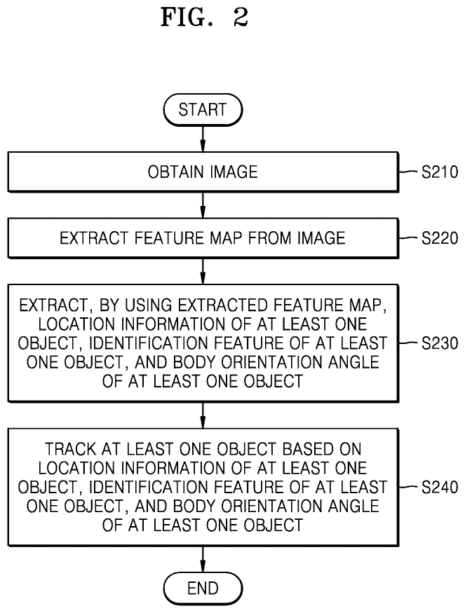

FIG. 2 illustrates a method of tracking an object by an electronic device, according to an embodiment of the disclosure.

In operation S210, the electronic device 2000 may obtain an image. The electronic device 2000 according to an embodiment may capture an image by using a camera included in the electronic device 2000 and obtain the image in real time. The camera may be installed within the electronic device 2000 or may be connected externally. In addition, the electronic device 2000 according to an embodiment may obtain an image from an external device in real time through a communication interface included in the electronic device 2000. For example, the electronic device 2000 may receive an image obtained from an external camera, in real time through the communication interface.

According to an embodiment, the obtained image may include at least one object to be tracked. In addition, the obtained image may include objects of different classes from each other.

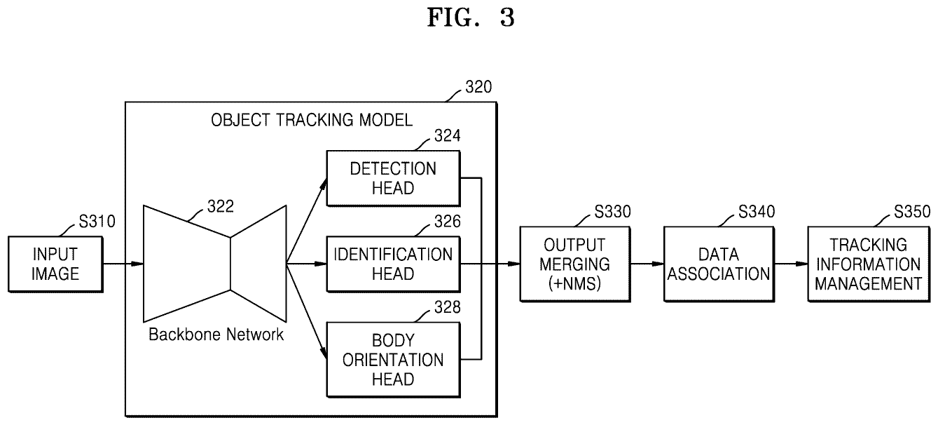

In operation S220, the electronic device 2000 may extract a feature map from the image. The feature map according to an embodiment may be a feature map for performing a plurality of tasks related to object tracking. According to an embodiment, the electronic device 2000 may extract the feature map from the image through a backbone network of an object tracking model. In an embodiment, the object tracking model is a multi-task artificial intelligence model for tracking an object and may include a backbone network, a detection head, an identification head, and a body orientation head. Each of the backbone network and the heads may each include at least one layer. A detailed description of the object tracking model is provided below with reference to FIG. 3.

In operation S230, the electronic device 2000 may extract, by using the extracted feature map, location information of the at least one object, identification features of the at least one object, and a body orientation angle of the at least one object. In an embodiment, the location information of the object may refer to a bounding box that represents a location and size of the object as a rectangle within the obtained image. According to an embodiment, the location information of the at least one object, the identification features of the at least one object, and the body orientation angle of the at least one object may be extracted by the detection head, the identification head, and the body orientation head of the object tracking model according to an embodiment, respectively.

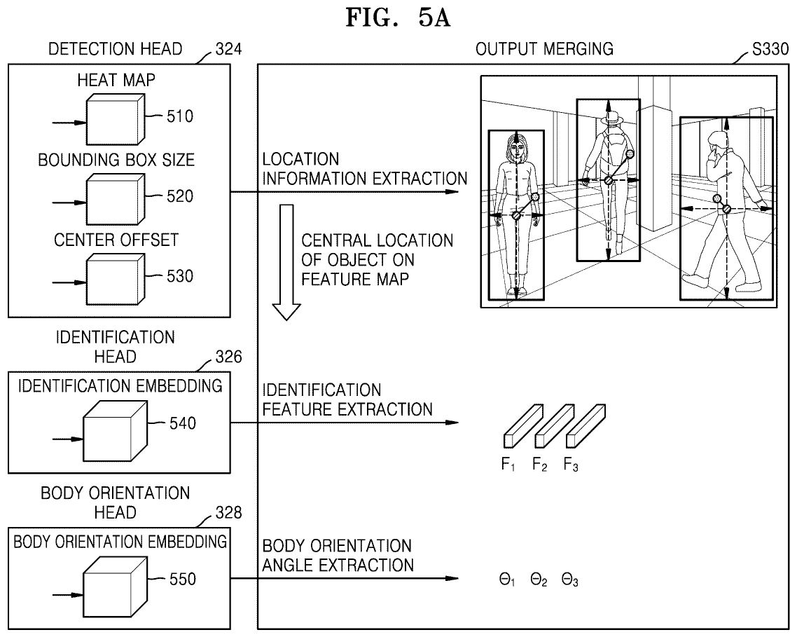

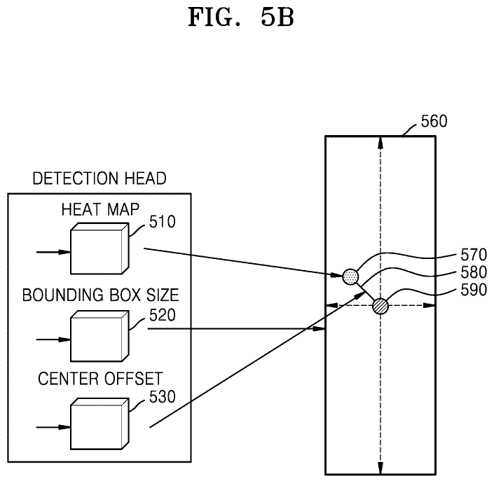

According to an embodiment, the identification features of the at least one object and the body orientation angle of the at least one object may be extracted based on the location information of the at least one object. A detailed description of a method of extracting identification features and body orientation angle of at least one object based on location information of the at least one object is provided below with reference to FIG. 5A.

In operation S240, the electronic device 2000 may track the at least one object based on the extracted location information of the at least one object, identification features of the at least one object, and body orientation angle of the at least one object. According to an embodiment, the operation of tracking the at least one object based on the extracted location information of the at least one object, identification features of the at least one object, and body orientation angle of the at least one object may include a data association process and a tracking information management process.

In an embodiment, the data association may refer to a process in which the electronic device 2000 compares each of at least one detected object with objects that have been previously tracked, and matches same with one of the objects that have been previously tracked. In an embodiment, a match between two objects may mean that the two objects are determined as the same object by the electronic device 2000. The electronic device 2000 may perform the data association process based on the extracted location information of the at least one object, identification features of the at least one object, and body orientation angle of the at least one object.

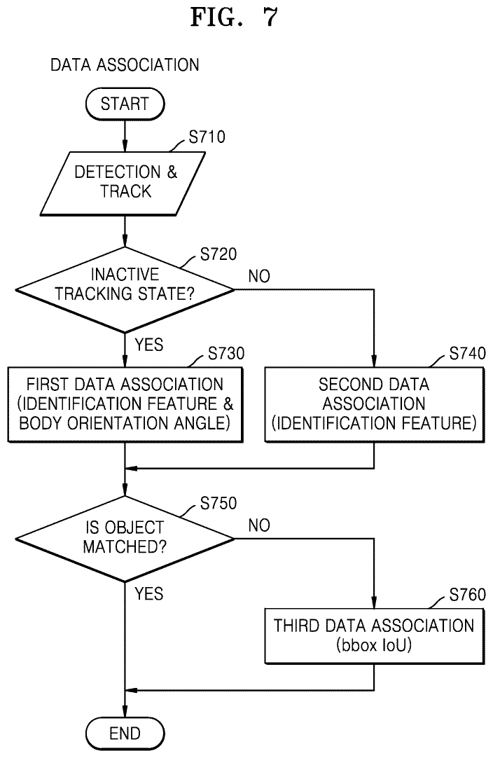

According to an embodiment, in the data association process, the electronic device 2000 may perform a first data association process or a second data association process, depending on whether an object to compared with the detected object is in an active tracking state, and may perform a third data association process when the two objects do not match with each other. In an embodiment, the object in the active tracking state may be or correspond to an object that was matched within a preset period from an image acquisition time among the objects being tracked. That is, the object in the active tracking state may be or correspond to an object of which the period from the last matching time of the corresponding object to the image acquisition time is less than or equal to the preset period. Conversely, the object in an inactive tracking state may be or correspond to an object that was not matched within the preset period from the image acquisition time among the objects being tracked. A detailed description of the data association process is provided below with reference to FIGS. 7 to 10.

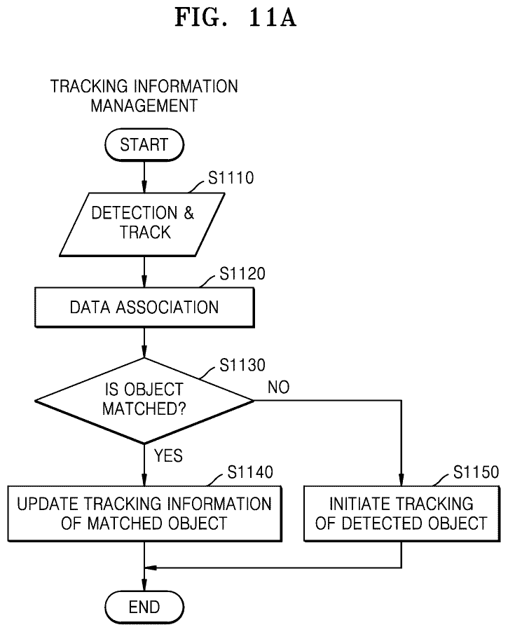

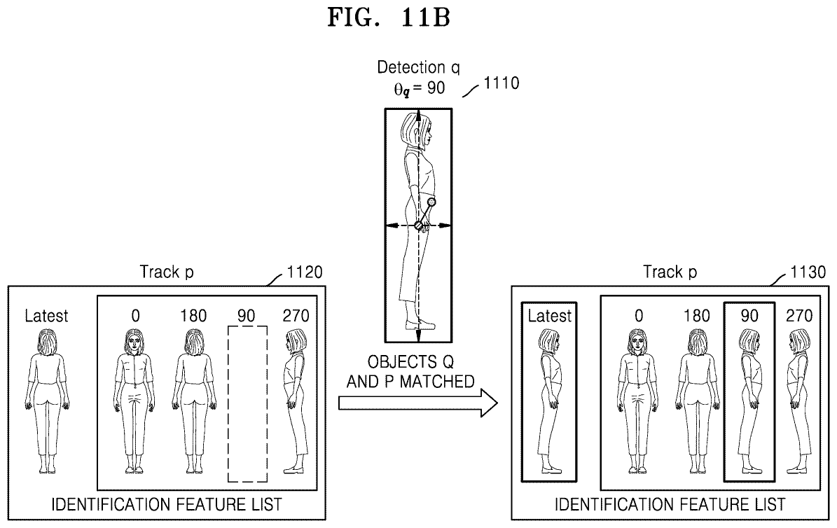

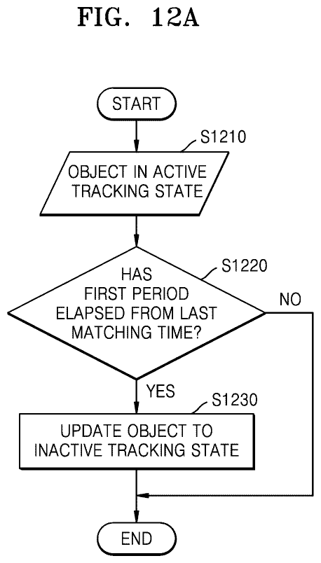

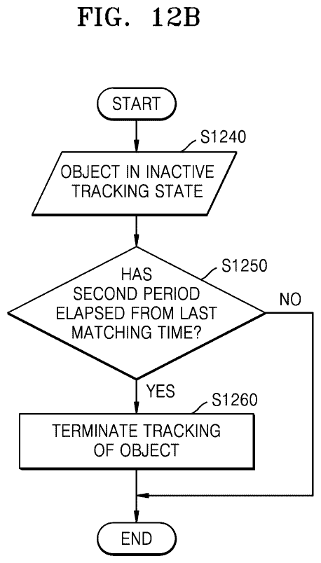

According to an embodiment, the electronic device 2000 may perform the tracking information management process after the data association process. The electronic device 2000 may update the identification feature list and the last matching time included in the tracking information, or may initiate tracking of a new object. In addition, the electronic device 2000 may determine whether the object is in the active tracking state based on the last matching time of the object, and update same to the inactive tracking state or terminate tracking of the object. A detailed description of the tracking information management process is provided below with reference to FIGS. 11 to 12.

FIG. 3 illustrates a process of tracking an object by using an object tracking model, according to an embodiment of the disclosure.

Referring to FIG. 3, the electronic device 2000 may track an object by using an object tracking model 320.

In operation S310, the electronic device 2000 may input an obtained image to the object tracking model 320. The electronic device 2000 may store the object tracking model 320 in a memory and use same, or may use the object tracking model 320 stored in an external server. When the electronic device 2000 uses the object tracking model 320 stored in the external server, the electronic device 2000 may transmit the obtained image to the external server through the communication interface. The external server may input the image obtained from the electronic device 2000 to the object tracking model 320 so as to output a plurality of pieces of output data including location information, identification features, and body orientation angle of at least one object. The electronic device 2000 may receive the plurality of pieces of output data of the object tracking model 320 from the external server. Below, for convenience of descriptions, it is described as an example that the electronic device 2000 stores the object tracking model 320 in a memory and uses the object tracking model 320 stored in the memory.

The object tracking model 320 according to an embodiment may include a backbone network 322, a detection head 324, an identification head 326, and a body orientation head 328. The object tracking model 320 is a multi-task artificial intelligence model for object tracking and may perform an object location detection task, an object identification task, and an object body orientation detection task in parallel. The backbone network 322 and each of the heads may each include at least one layer.

According to an embodiment, the backbone network 322 may extract a feature map from an image. The backbone network 322 may include a CNN structure including a plurality of layers. The extracted feature map may be used for the object location detection task, the object identification task, and the object body orientation detection task. That is, the extracted feature map may be input data for the detection head 324, the identification head 326, and the body orientation head 328. By using a feature map rather than an image as input data for each of the heads of the object tracking model 320, the accuracy and processing speed of the task performed in each of the heads may be improved. The backbone network 322 may divide the image into a plurality of channels through convolution layers having a plurality of filters and pooling layers and downsample same, to be suitable for use in each task. For example, the backbone network 322 may downsample the image by ¼ and extract a feature map. In this case, when a size of the image is (W, H), a size of the feature map may be (W/4, H/4).

According to an embodiment, the detection head 324 may perform the object location detection task. That is, the detection head 324 may extract location information of the at least one object from the extracted feature map. In addition, the identification head 326 may perform the object identification task. That is, the identification head 326 may extract identification features of the at least one object from the extracted feature map. In addition, the body orientation head 328 may perform the object body orientation detection task. That is, the body orientation head 328 may extract a body orientation angle of the at least one object from the extracted feature map.

According to an embodiment, the detection head 324 may include a heat map head, a bounding box size head, and a center offset head. The heat map head may extract a heat map indicating a central location of the at least one object from the feature map. The heat map may have heat map scores corresponding to the respective pixels of the heat map, and may have a peak heat map score at a central location of the at least one object on the feature map. For example, when the size of the feature map is (Wₒᵤₜ, Hₒᵤₜ), a size of output data of the heat map head may be (Wₒᵤₜ, Hₒᵤₜ, 1). In this case, the last dimension may correspond to the heat map score. According to an embodiment, the bounding box size head may extract,

from the feature map, an x-axis length and y-axis length of a bounding box corresponding to each pixel of the feature map. In an embodiment, the bounding box size may be or correspond to a size including the x-axis length and y-axis length of the bounding box. In this case, an x-axis length and a y-axis length of a bounding box corresponding to the central location of the at least one object on the feature map may be an x-axis length and a y-axis length of the bounding box of the at least one object, respectively. For example, when the size of the feature map is (Wₒᵤₜ, Hₒᵤₜ), a size of output data of the bounding box size head may be (Wₒᵤₜ, Hₒᵤₜ, 2). In this case, the last dimension may correspond to the x-axis length and the y-axis length of the bounding box.

According to an embodiment, the center offset head may extract, from the feature map, center offsets corresponding to the respective pixels of the feature map. In an embodiment, the center offset may be an offset for obtaining a central location on an image of the at least one object. In this case, a center offset corresponding to the central location of the at least one object on the feature map may be a center offset of the at least one object. For example, when the size of the feature map is (Wₒᵤₜ, Hₒᵤₜ), a size of output data of the center offset head may be (Wₒᵤₜ, Hₒᵤₜ, 2). In this case, the last dimension may correspond to the center offset on the x-axis and the center offset on the y-axis.

According to an embodiment, the identification head 326 may include a convolution layer having a plurality of filters. When the size of a feature map, which is input data of the identification head 326, is (Wₒᵤₜ, Hₒᵤₜ), the size of output data of the identification head 326 may be (Wₒᵤₜ, Hₒᵤₜ, D_{id}). In this case, Did may be a size of an identification embedding vector corresponding to each pixel of the feature map. For example, when identification features of an object are extracted with 128 criteria, the identification head 326 may include a convolution layer having 128 filters. In this case, the size of output data of the identification head 326 may be (Wₒᵤₜ, Hₒᵤₜ, 128) The identification head 326 may extract identification embedding vectors. In an embodiment, the identification embedding vector is included in the output data of the identification head 326. The identification embedding vector may be or correspond to an identification feature corresponding an arbitrary pixel of the feature map. That is, in an embodiment, the identification embedding vector and the identification feature may be used interchangeably. In this case, an identification embedding vector corresponding to the central location of the at least one object on the feature map may be an identification feature of the at least one object.

According to an embodiment, the body orientation head 328 may include a convolution layer having as many filters as the number of representative angles. When the size of a feature map, which is input data of the body orientation head 328, is (Wₒᵤₜ, Hₒᵤₜ), the size of output data of the body orientation head 328 may be (Wₒᵤₜ, Hₒᵤₜ, Dₒᵣᵢ). In this case, Dₒᵣᵢ may be a size of a body orientation embedding vector corresponding to each pixel of the feature map. For example, when the representative angles are 0 degrees, 90 degrees, 180 degrees, and 270 degrees, the body orientation head 328 may include a convolution layer having four filters. The filters of the convolution layer may correspond to the representative angles, respectively. In this case, the size of output data of the body orientation head 328 may be (Wₒᵤₜ, Hₒᵤₜ, 4) The body orientation head 328 may extract body orientation embedding vectors. In an embodiment, the body orientation embedding vector is data included in the output data of the body orientation head 328 and corresponds to an arbitrary pixel of the feature map. In this case, a body orientation embedding vector corresponding to the central location of the at least one object on the feature map may be a body orientation embedding vector of the at least one object. The body orientation embedding vector of an object may include elements respectively corresponding to the representative angles, and values of the elements may be scores for the representative angles, respectively.

According to an embodiment, when there are a plurality of classes of objects tracked by the object tracking model 320, the output data of the detection head 324, the identification head 326, and the body orientation head 328 may have an increased number of elements of the vector of the last dimension or an additional dimension may be added. For example, when there are C classes of objects in the obtained image, and the size of the feature map, which is the input data of the respective heads, is (Wₒᵤₜ, Hₒᵤₜ), the size of the output data of the heat map head included in the detection head 324 may be (Wₒᵤₜ, Hₒᵤₜ, C). The heat map head may extract a heat map corresponding to each of the classes. In addition, the size of output data of the identification head 326 may be (Wₒᵤₜ, Hₒᵤₜ, D_{id}, C). The identification head 326 may extract identification embedding vectors corresponding to the respective pixels of the feature map for each class. In addition, the size of output data of the body orientation head 328 may be (Wₒᵤₜ, Hₒᵤₜ, Dₒᵣᵢ, C). The body orientation head 328 may extract body orientation embedding vectors corresponding to the respective pixels of the feature map for each class.

When there are a plurality of classes of objects, the electronic device 2000 according to an embodiment may identify the classes of objects based on heat map scores of heat maps respectively corresponding to the classes extracted from the heat map head. For example, the heat map head may extract a heat map having a peak heat map score only at a central location of the at least one object corresponding to the respective classes. The electronic device 2000 may determine at least one object corresponding to the respective classes based on a pixel having the peak heat map score in the heat maps corresponding the respective classes, and determine a central location of each object on the feature map.

Based on the central location of the at least one object on the feature map corresponding to the respective classes, the electronic device 2000 according to an embodiment may extract identification features and body orientation angles of each object from identification embedding vectors and body orientation embedding vectors respectively extracted from the identification head 326 and the body orientation head 328 corresponding to the same class. Below, for convenience of descriptions, it is described as an example that there is only one class of objects included in the obtained image.

In operation S330, the electronic device 2000 may perform an output merging process. That is, the electronic device 2000 may merge output data output from the detection head 324, the identification head 326, and the body orientation head 328. The electronic device 2000 may extract location information of the at least one object from the detection head 324, and extract, based on the extracted location information of the at least one object, identification features of the at least one object and body orientation angles of the at least one object from identification embedding vectors and body orientation embedding vectors respectively output from the identification head 326 and the body orientation head 328.

Detailed descriptions of the output data output from each of the heads and the output merging process are provided below with reference to FIG. 5A.

In operation S340, the electronic device 2000 may perform a data association process. That is, the electronic device 2000 may match the at least one object with one of objects that have been previously tracked, based on the location information, identification features, and body orientation angle of the at least one object.

In operation S350, the electronic device 2000 may perform a tracking information management process. That is, the electronic device 2000 may update the identification feature list and the last matching time included in the tracking information, or may initiate tracking of a new object. In addition, the electronic device 2000 may determine whether the object is in the active tracking state based on a time at which the object is detected last, and update it to an inactive tracking state or terminate tracking of the object.

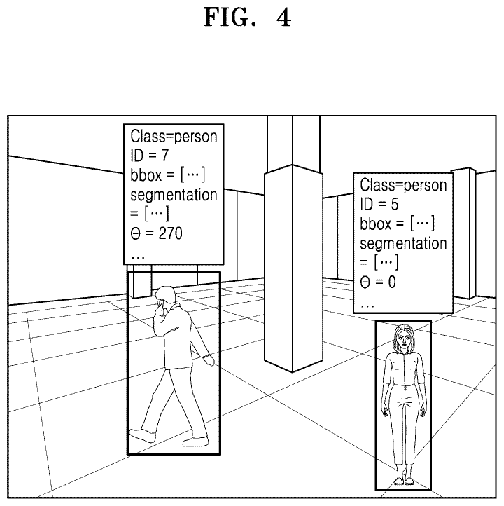

FIG. 4 illustrates an example operation of training image data of an object tracking model according to an embodiment of the disclosure.

The object tracking model according to an embodiment may be trained by using a training image data set including various annotations. The object tracking model may be trained by the electronic device 2000 or by an external server. When the object tracking model is trained by the electronic device 2000, the electronic device 2000 may receive a training image data set from an external database through a communication interface. When the object tracking model is trained by the external server, the object tracking model may be stored in the external server, or the electronic device 2000 may receive the object tracking model from the external server through the communication interface and store same. Below, for convenience of descriptions, it is described as an example that the object tracking model is trained by the electronic device 2000.

According to an embodiment, training image data used for training an object tracking model may include at least one of annotations for the class, ID, bounding box information, segmentation information, and body orientation angle of the object. However, the training image data is not limited to the above examples, and may include more annotations.

According to an embodiment, the class of the object may represent a type of the object. For example, the class of the object may be person, vehicle, animal, or the like. The bounding box information of the object may include x and y coordinates of each vertex of the bounding box. Segmentation may be or correspond to dividing each object into parts within the image. The segmentation information of an object may include x and y coordinates of a boundary of the object measured at regular intervals. The body orientation angle of the object may be labeled with a representative angle closest to a body orientation angle of an actual object. The training image data set may include at least one object corresponding to each representative angle.

According to an embodiment, the central location of the object on the feature map may be obtained through bounding box coordinates of the object in the training image data. For example, when the feature map may be extracted by downsampling the image by ¼, and the bounding box coordinates of the object on the learning image data are (x₁, y₁, x₂, y₂), the central location of the object on the learning image data may be and the central location of the object on

$$( ⌊ \frac{{x}_{1} + {x}_{2}}{8} ⌋ , ⌊ \frac{{y}_{1} + {y}_{2}}{8} ⌋ ) .$$

the feature map may be

$$( \frac{{x}_{1} + {x}_{2}}{2} , \frac{{y}_{1} + {y}_{2}}{2} ) ,$$

This is to represent the central location of the object on the feature map as x, y coordinates, which are integers, on the feature map.

Similarly, the bounding box size of the object may be obtained through the bounding box coordinates of the object in the training image data. For example, when the bounding box coordinates of the object is (x₁, y₁, x₂, y₂), the bounding box size of the object may be (x₂−x₁. y₂−y₁). The center offset of the object may be obtained through the bounding box coordinates of the object in the learning image data and the central location of the object on the feature map. For example, when the feature map may be extracted by downsampling the image by ¼, and the bounding box coordinates of the object are (x₁, y₁, x₂, y₂), the center offset of the object may be

$$( \frac{{x}_{1} + {x}_{2}}{8} - ⌊ \frac{{x}_{i} + {x}_{2}}{8} ⌋ , \frac{{y}_{1} + {y}_{2}}{8} - ⌊ \frac{{y}_{1} + {y}_{2}}{8} ⌋ ) .$$

This is to obtain an accurate central location of the object on the image.

According to an embodiment, the identification features of the object may be determined based on segmentation information of the object, color combinations of the object, bounding box information of the object, or the like of the training image data. The electronic device 2000 may train the object tracking model such that identification features extracted by the identification head have high similarity between identical objects and have low similarity between different objects.

According to an embodiment, the body orientation angle of the object may be determined based on the segmentation information of the object, the bounding box information of the object, or the like of the training image data. For example, the appearance of the object may be distinguished for each representative angle. The electronic device 2000 may train the object tracking model so that the body orientation head of the object estimates the body orientation angle, based on the appearance of the object distinguished for each representative angle.

According to an embodiment, the electronic device 2000 may calculate a loss value for each of the heat map of the object, the bounding box size of the object, the center offset of the object, the identification feature of the object, and the body orientation angle of the object, and train the object tracking model to minimize a total loss value. In the cases of the heat map of the object, the bounding box size of the object, and the center offset of the object, the electronic device 2000 may set such that the loss value decreases as a difference between a ground-truth and an estimated value decreases.

According to an embodiment, in the case of the identification feature of the object, a fully-connected layer and a softmax function may be used for learning. As a result of inputting the estimated identification feature to the fully-connected layer, it may be set such that the loss value decreases with the increase in the probability for the same object. In the case of the body orientation angle of the object, it may be set such that the loss value decreases with the increase in a value of an element corresponding to a representative angle, which is the body orientation angle of the object, in the body orientation embedding vector of the object.

According to an embodiment, the training image data set may include objects corresponding to different classes. For example, the training image data set may include people and vehicles as objects to be tracked. The object tracking model may be trained to extract a heat map corresponding to each class, an identification embedding vector corresponding to each pixel of a feature map for each class, and a body orientation embedding vector corresponding to each pixel of the feature map for each class from the heat map head, the identification head, and the body orientation head, respectively. For example, the heat map head may include a layer having as many filters as the number of classes, and each of the filters may be trained to extract a heat map corresponding to each class. The electronic device 2000 may set such that the loss value decreases as a heat map score of the heat map corresponding to each class increases at the central location of the at least one object corresponding to each class.

FIG. 5A illustrates a method of extracting location information, an identification feature, and a body orientation angle of an object by using respective heads of an object tracking model, according to an embodiment of the disclosure.

Referring to FIG. 5A, the electronic device 2000 may extract the location information, identification feature, and body orientation angle of the object by merging output data output from each of the heads of the object tracking model. FIG. 5A shows an example in which three objects are detected in the image, but more or fewer objects may be detected in the image.

According to an embodiment, the detection head 324 of the object tracking model may include a heat map head, a bounding box size head, and a center offset head. Each of the heads included in the detection head 324 may use a feature map extracted from a backbone network of the object tracking model as input data. The heat map head, the bounding box size head, and the center offset head may extract a heat map 510, bounding box size data 520, and center offset data 530, respectively. The heat map 510 may have the same size as the feature map, and may have heat map scores corresponding to the respective pixels of the heat map 510. In addition, the heat map 510 may have a peak heat map score at the central location of the at least one object on the feature map. The heat map head may include a max pooling layer for obtaining a peak heat map score of the heat map 510. According to an embodiment, after applying the max pooling, the heat map head may extract the top k (e.g., 100) pixels in the order of the highest heat map score among the peak heat map scores. Here, k may be a preset value.

According to an embodiment, the bounding box size and center offset of the at least one object may be extracted based on the central location of the at least one object on the feature map. In the bounding box size data 520 and the center offset data 530, the bounding box size and the center offset corresponding to the central location of the at least one object on the feature map may be the bounding box size and center offset of the at least one object.

According to an embodiment, the electronic device 2000 may extract location information of the at least one object based on the central location of the at least one object on the feature map, the bounding box size of the at least one object, and the center offset of the at least one object. A detailed description of a method of extracting location information of at least one object is provided with reference to FIG. 5B.

According to an embodiment, the identification head 326 of the object tracking model may extract identification embedding vectors 540. Each of the pixels of the feature map may have a corresponding identification embedding vector. For example, when the identification head 326 includes a convolution layer having 128 filters, the identification embedding vector may be a vector having 128 elements. The electronic device 2000 may extract identification features of the at least one object based on the central location of the at least one object on the feature map obtained from the heat map 510 of the detection head 324. The electronic device 2000 may determine an identification embedding vector corresponding to the central location of the at least one object on the feature map as the identification feature of the at least one object.

According to an embodiment, the body orientation head 328 of the object tracking model may extract body orientation embedding vectors 550. Each of the pixels of the feature map may have a corresponding body orientation embedding vector. For example, when the body orientation head 328 includes a convolution layer having four filters, the body orientation embedding vector may be a vector having four elements. The electronic device 2000 may extract a body orientation embedding vector of the at least one object based on the central location of the at least one object on the feature map. The electronic device 2000 may determine the body orientation embedding vector corresponding to the central location of the at least one object on the feature map as the body orientation embedding vector of the at least one object.

The electronic device 2000 according to an embodiment may extract a body orientation angle of the at least one object based on an element having a maximum value among elements of the body orientation embedding vector of the at least one object. The electronic device 2000 may determine a representative angle corresponding to the element having the maximum value among the elements of the body orientation embedding vector of the at least one object as the body orientation angle of the at least one object.

FIG. 5B illustrates a method of extracting location information of an object by using a detection head of an object tracking model, according to an embodiment of the disclosure.

Referring to FIG. 5B, the electronic device 2000 according to an embodiment may extract location information of the object based on output data output from the heat map head, the bounding box size head, and the center offset head included in the detection head.

The electronic device 2000 according to an embodiment may extract the heat map 510 through the heat map head, and obtain a central location 570 of the object on the feature map from the extracted heat map 510. In addition, the electronic device 2000 may extract bounding box size data 520 through the bounding box size head. The electronic device 2000 may determine the x-axis length and y-axis length of a bounding box corresponding to the central location 570 of the object on the feature map as the bounding box size 560 of the object. In addition, the electronic device 2000 may extract center offset data 530 through the center offset head. The electronic device 2000 may determine a center offset corresponding to the central location 570 of the object on the feature map as a center offset 580 of the object. The electronic device 2000 may determine a central location 590 of the object on the image based on the obtained central location 570 of the object on the feature map and the center offset 580 of the object.

The electronic device 2000 may determine location information of the object based on the central location 590 of the object on the image and the bounding box size 560 of the object. The electronic device 2000 may determine a bounding box centered on the central location 590 of the object on the image and having the x and y coordinate lengths of the bounding box size 560 of the object as the x and y coordinate lengths, as the location information of the object.

According to an embodiment, the electronic device 2000 may perform a non-maximum suppression (NMS) on the bounding boxes determined based on the central location 590 of the object on the image and the bounding box size 560 of the object. The electronic device 2000 may remove a bounding box corresponding to a pixel having a heat map score less than or equal to a preset reference heat map score (e.g., 0.3) among the top k pixels extracted based on the heat map score.

FIG. 6 illustrates object detection information and object tracking information according to an embodiment of the disclosure.

In an embodiment, object detection information 610 is information obtained when an object is detected in an image obtained by the electronic device 2000, and may include output data output through the object tracking model. The object detection information 610 according to an embodiment may include a class of the object, a bounding box of the object, a heat map score, an identification feature of the object, a body orientation angle of the object, but is not limited to the above examples.

In an embodiment, object tracking information 620 is information about an object being tracked by the electronic device 2000, and may include at least one of a class of the object, an ID of the object, a trajectory of the object, an identification feature list of the object, and a last matching time of the object, but the disclosure is not limited to the above examples. For example, the object tracking information 620 may include a tracking state of the object. According to an embodiment, the last matching time of the object may be stored on a frame-by-frame basis.

FIG. 7 illustrates a data association process according to an embodiment of the disclosure.

In operation S710, the electronic device 2000 according to an embodiment may compare at least one detected object with objects that have been previously tracked. The electronic device 2000 may compare each of the at least one detected object with all objects that have been previously tracked. The electronic device 2000 may create a pair of one of the at least one detected object and one of the objects that have been previously tracked, and compare the two objects. The electronic device 2000 may compare each of the at least one detected object with all objects that have been previously tracked, and match same with an object with the highest similarity.

In operation S720, the electronic device 2000 may determine whether each of the objects that have been previously tracked is in the inactive tracking state. For example, the electronic device 2000 may obtain images in real time and detect at least one object in the images. For example, when an object p, which has been previously tracked, has not been matched for 30 frames or more from the last matching time of the object p based on an image acquisition time, the electronic device 2000 may determine that the object p is in the inactive tracking state. Conversely, when the image acquisition time is less than or equal to 30 frames from the last matching time of the object p, the electronic device 2000 may determine that the object p is in the active tracking state. The electronic device 2000 may perform a first data association (S730) when comparing the at least one detected object with an object in the inactive tracking state, and perform a second data association (S740) when comparing same with an object in the active tracking state.

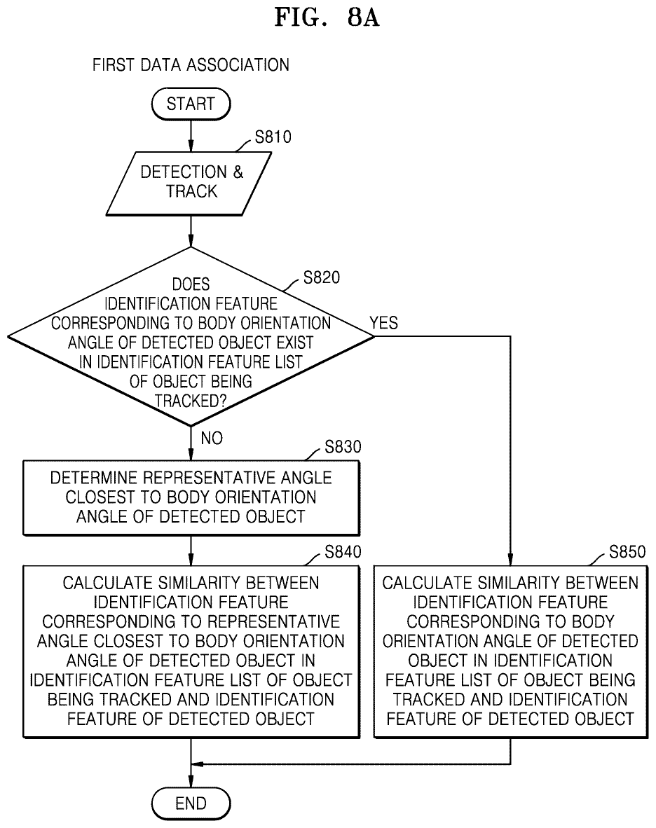

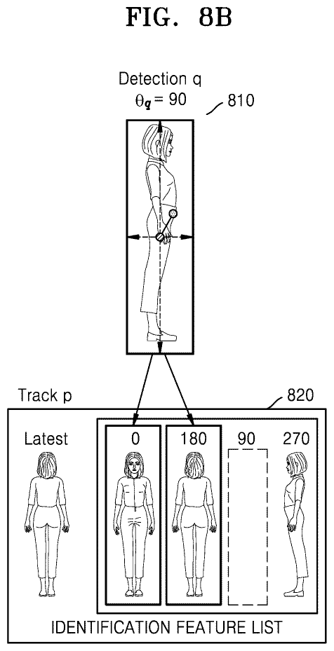

In operation S730, when comparing the at least one detected object with the object in the inactive tracking state, the electronic device 2000 may perform a first data association process. For example, when the detected object q and the object p that has been previously tracked correspond to the same object, and the object p is in the inactive tracking state, body orientation angles of the object q and the object p may have changed. For example, when the object p disappears from the screen after the last matching time and then reappears 30 frames after the last matching time, a body orientation angle of the reappearing object p may have changed. As the body orientation angle has changed, identification features of the object q and the object p may have low similarity even though they are the same object. Accordingly, the electronic device 2000 may consider the identification features of the object and the body orientation angle of the object during the first data association process. A detailed description of the first data association process is provided with reference to FIGS. 8A and 8B.

In operation S740, when comparing the at least one detected object with the object in the active tracking state, the electronic device 2000 may perform a second data association process. For example, when the detected object q and the object p that has been previously tracked correspond to the same object, and the object p is in the active tracking state, body orientation angles of the object q and the object p may be similar. For example, when the object p is matched and tracked on a frame-by-frame basis in images obtained in real time, a movement of the object p is continuous, and thus the body orientation angle cannot be significantly changed. In this case, the electronic device 2000 may consider only the identification features of the object during the second data association process.

In operation S750, the electronic device 2000 may determine whether an object identical to each of the at least one detected object exists in the objects that have been previously tracked. According to an embodiment, when the similarity between identification features of the two objects is greater than or equal to a predetermined reference value according to the first data association or the second data association, the electronic device 2000 may determine that the two objects are the same object. The electronic device 2000 may perform a third data association (S760) on an object of the at least one detected object that does not match with the objects that have been previously tracked. For example, when the similarity between the identification features of the detected object q and each of the objects that have been previously tracked is all less than a predetermined reference value according to the first data association or second data association of the object q and the objects that have been previously tracked, the electronic device 2000 may perform a third data association (S760) on the object q.

In operation S760, the electronic device 2000 may perform a third data association process on an object of the at least one detected object that does not match with the objects that have been previously tracked. The electronic device 2000 may determine whether an object identical to each of the at least one detected object exists among the objects that have been previously detected, based on Intersection over Union (IoU) between bounding boxes (bbox) of the at least one detected object and the objects that have been previously detected. The IoU between the bounding boxes is an indicator for determining a degree to which two bounding boxes overlap, and corresponds to a value obtained by dividing an area in which the two bounding boxes overlap by a combined area of the two bounding boxes. For example, when the IoU between the bounding boxes of the detected object q and the object p that has been previously tracked is greater than or equal to a predetermined reference value, the electronic device 2000 may determine that the object q and the object p are the same object. Alternatively, the electronic device 2000 may select objects where an IoU between the bounding boxes of the detected object q and each of the objects that have been previously detected is greater than or equal to the predetermined reference value. The electronic device 2000 may determine an object having the largest IoU value among the selected objects as an object identical to the object q.

According to an embodiment, the electronic device 2000 may perform the first data association or second data association process on the at least one detected object and all the objects that have been previously detected, and select objects of which the similarity in identical feature to each of the at least one detected object is greater than or equal to a predetermined reference value. The electronic device 2000 may determine an object with the highest similarity among the selected objects corresponding to each of the at least one detected object as an object identical to each of the corresponding at least one detected object.

FIG. 8A illustrates the first data association process according to an embodiment of the disclosure.

In operation S710, the electronic device 2000 according to an embodiment may compare at least one detected object with objects in the inactive tracking state among objects that have been previously tracked. Because operation S810 corresponds to operation S710, a detailed description thereof are omitted.

In operation S820, in each pair of a detected object and an object being tracked, the electronic device 2000 may determine whether an identification feature corresponding to a body orientation angle of the detected object exists in an identification feature list of the object being tracked. For example, when the electronic device 2000 compares the detected object q with the object p that has been previously tracked, the electronic device 2000 may determine whether an identification feature

$${F}_{p}^{{θ}_{q}}$$

of the object p corresponding to a body orientation angle θ_{q} of the object q exists in an identification feature list of the object p. θ_{q} may correspond to one of representative angles. For example, while the object p is being tracked, when the body orientation angle has not been detected to be in a θ_{q} state,

$${F}_{p}^{{θ}_{q}}$$

may not exist in the identification feature list of the object p. The electronic device 2000 may determine a representative angle closest to θ_{q} (S830) when

$${F}_{p}^{{θ}_{q}}$$

does not exist, and calculate the similarity between an identification feature F_{q}^{t} of the object q and

$${F}_{p}^{{θ}_{q}}$$

(S850) when

$${F}_{p}^{{θ}_{q}}$$

exists. Here, t may be image acquisition time.

In operation S830, in each of the pairs of the detected object and the object being tracked, the electronic device 2000 may determine a representative angle closest to the body orientation angle of the detected object with respect to pairs in which an identification feature corresponding to the body orientation angle of the detected object does not exist in the identification feature list of the object being tracked. For example, when

$${F}_{p}^{{θ}_{q}}$$

which is the identification feature corresponding to the body orientation angle of the detected object q, does not exist in the identification feature list of the object p that has been previously tracked, the electronic device 2000 may determine a representative angle [symbol] , which is closest to θ_{q}. For example, when the representative angles are 0 degrees, 90 degrees, 180 degrees, and 270 degrees, and θ_{q} is 90 degrees, [symbol] may be 0 degrees or 180 degrees. The electronic device 2000 may determine whether an identification feature corresponding to 0 degrees and 180 degrees exists, and determine a representative angle in which the identification feature exists as [symbol] .

If the identification feature exists in both representative angles, comparison may be made with one of the two identification features or with both identification features. Below, for convenience of descriptions, it is described as an example that comparison is made with one of the two identification features. If an identification feature does not exist in any of the two representative angles, the electronic device 2000 may determine whether an identification feature corresponding to each representative angle starting from a representative angle close to θ_{q}, and determine a representative angle in which the identification feature exists as [symbol] .

In operation S840, in each of the pairs of the detected object and the object being tracked, the electronic device 2000 may calculate the similarity between an identification feature corresponding to a representative angle closest to the body orientation angle of the detected object within the identification feature list of the object being tracked and the identification feature of the detected object. For example, when the electronic device 2000 compares the detected object q with the object p that has been previously tracked, the electronic device 2000 may calculate the similarity between F_{q}^{t} and an identification feature

$${F}_{p}^{}$$

of the object p corresponding to [symbol] . For example, the electronic device 2000 may calculate cosine similarity between F_{q}^{t} and

$${F}_{p}^{} .$$

In operation S850, in the pairs of the detected object and the object being tracked, with respect to pairs in which an identification feature corresponding to the body orientation angle of the detected object exists in the identification feature list of the object being tracked, the similarity between the identification feature corresponding to the body orientation of the detected object in the identification feature list of the object being tracked and the identification feature of the detected object may be calculated. For example, when comparing the detected object q and the object p that has been previously tracked, the electronic device 2000 may calculate the similarity between F_{q}^{t} and

$${F}_{p}^{{θ}_{q}} .$$

For example, the electronic device 2000 may calculate cosine similarity between F_{q}^{t} and

$${F}_{p}^{{θ}_{q}} .$$

FIG. 8B illustrates an example operation of the first data association process according to an embodiment of the disclosure.

The electronic device 2000 according to an embodiment may compare a detected object q 810 with an object p that has been previously tracked, during the first data association process. In this case, a body orientation angle of the detected object q 810 may be 90 degrees. An identification feature corresponding to 90 degrees may not exist in an identification feature list 820 of the object p. In this case, the electronic device 2000 may determine a representative angle closest to 90 degrees as 0 degrees or 180 degrees. The electronic device 2000 may calculate the similarity between an identification feature corresponding to 0 degrees or 180 degrees and an identification feature of the object q 810. According to an embodiment, the electronic device 2000 may calculate the similarity between all identification features corresponding to 90 degrees and 180 degrees and the identification feature of the object q 810.

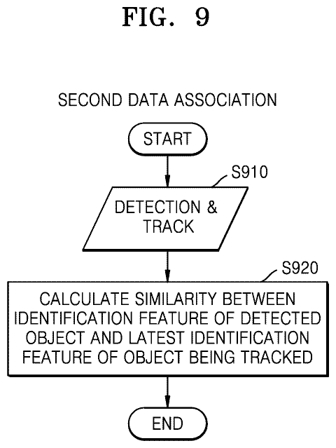

FIG. 9 illustrates the second data association process according to an embodiment of the disclosure.

In operation S910, the electronic device 2000 according to an embodiment may compare at least one detected object with objects in the active tracking state among objects that have been previously tracked. Because operation S910 corresponds to operation S710, a detailed description thereof are omitted.

In operation S920, the electronic device 2000 may calculate the similarity between an identification feature of the at least one detected object and the latest identification feature of each of objects that have been previously tracked. For example, when the electronic device 2000 compares the detected object q with the object p that has been previously tracked, the electronic device 2000 may calculate the similarity between F_{q}^{t} and the latest identification feature Fₚ^{L} of the object p. Fₚ^{L} may be an identification feature of the object p at a time when the object p was last matched. For example, the electronic device 2000 may calculate cosine similarity between F_{q}^{t} and Fₚ^{L}.

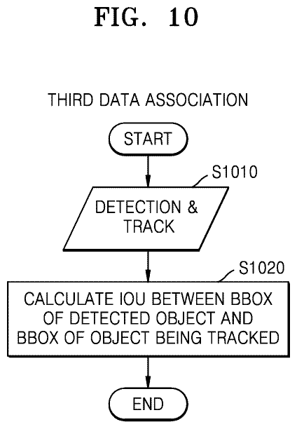

FIG. 10 illustrates the third data association process according to an embodiment of the disclosure.

In operation S1010, the electronic device 2000 according to an embodiment may compare at least one detected object with objects that have been previously tracked.

In operation S1020, the electronic device 2000 may calculate IoU between bounding boxes of the at least one detected object and each of the objects that have been previously tracked. For example, when the electronic device 2000 compares the detected object q with the object p that has been previously tracked, the electronic device 2000 may calculate the IoU between bounding boxes (bbox) of the object q and the object p. A description of operation S1020 is the same as a description of operation S760, and thus a detailed description thereof is omitted.

FIG. 11A illustrates the tracking information management process

according to an embodiment of the disclosure.

Referring to FIG. 11A, the electronic device 2000 according to an embodiment may update tracking information of objects that have been previously tracked, or initiate tracking of at least one detected object.

In operation S1110, the electronic device 2000 may compare the at least one detected object with the objects that have been previously tracked. Because operation S1110 corresponds to operation S710, a detailed description thereof are omitted.

In operation S1120, the electronic device 2000 may perform a data association process between the at least one detected object and the objects that have been previously tracked. Because the data association process is described with reference to FIGS. 7 to 10, a detailed description thereof is omitted.

In operation S1130, the electronic device 2000 may determine whether an object identical to each of the at least one detected object exists in the objects that have been previously tracked. For example, in the data association process, when the electronic device 2000 compares the detected object q with the object p that has been previously tracked, the electronic device 2000 may determine whether the object q and the object p are the same object. When the object q and the object p are matched during the data association process, the electronic device 2000 may update (S1140) tracking information of the object p. The electronic device 2000 may determine whether an object matched with the object q exists with respect to the object p and all the objects that have been previously tracked. When an object matching the object q does not exist, the electronic device 2000 may initiate tracking of the object q (S1150).

In operation S1140, the electronic device 2000 may update tracking information of objects that are matched with the at least one detected object, among the objects that have been previously tracked. For example, when the detected object q and the object p that has been previously tracked are matched during the data association process, the electronic device 2000 may update tracking information of the object p based on detection information of the object q. A detailed description of the process of updating the tracking information of the object p is provided with reference to FIG. 11B.

In operation S1150, the electronic device 2000 may initiate tracking of an object that is not matched with any of the objects that have been previously tracked, among the at least one detected object. For example, when the detected object q is not matched with any of the objects that have been previously tracked, the electronic device 2000 may initiate tracking of the object q. For example, the electronic device 2000 may store tracking information for the object q in a tracking database. The electronic device 2000 may determine an ID of the object q as q and start tracking a trajectory of object q. The electronic device 2000 may add, to an identification feature list of the object q, an extracted identification feature F_{q}^{t} of the object q as the latest identification feature of the object q and an identification feature corresponding to a body orientation angle θ_{q} of the object q. The electronic device 2000 may determine t, which is an image acquisition time, as the last matching time of the object q.

FIG. 11B illustrates a process of updating tracking information of an object, according to an embodiment of the disclosure.

Referring to FIG. 11B, when an object q 1110 and an object p are matched, the electronic device 2000 may update tracking information of the object p based on detection information of the object q 1110. For example, an identification feature corresponding to 90 degrees may not exist in an identification feature list 1120 of the object p before update. When a body orientation angle θ_{q} of the object q 1110 is 90 degrees and the object q 1110 and the object p are matched, the electronic device 2000 may update, by using an identification feature of the object q 1110, a latest identification feature and identification feature corresponding to 90 degrees of the object p. Accordingly, all identification features respectively corresponding to representative angles may exist in an updated identification feature list 1130 of the object p.

The electronic device 2000 may update the identification feature list 1120 of the object p and other information included in the tracking information of the object p. The electronic device 2000 may update a trajectory of the object p based on detected location information of the object q 1110. In addition, the electronic device 2000 may update an image acquisition time t, which is a time at which the object q 1110 is detected, as the last matching time of the object p.

FIG. 12A illustrates a process of updating a tracking state of an object, according to an embodiment of the disclosure.

According to an embodiment, in a tracking information management process, the electronic device 2000 may update tracking states of objects that have been previously tracked. Based on a period during which no matching has occurred from the last matching time, the electronic device 2000 may update an object to the inactive tracking state or terminate tracking of the object.

In operation S1210, the electronic device 2000 may set, as targets for tracking state update, objects in the active tracking state among the objects that have been previously tracked.

In operation S1220, the electronic device 2000 may determine, based on an image acquisition time, whether a first period has elapsed from a time at which each of the objects being tracked was last matched. That is, the electronic device 2000 may determine whether each of the objects being tracked has not been matched for the first period from the last matching time. The first period may be a preset period of time that serves as a reference for the active tracking state and inactive tracking state of an object. For example, the electronic device 2000 may set the first period to 30 frames. The electronic device 2000 may update, to the inactive tracking state, tracking states of objects for which the first period has elapsed from the last matching time, among the objects being tracked (S1230). The electronic device 2000 may not update tracking states of objects for which the first period has not yet elapsed from the last matching time, among the objects being tracked.

In operation S1230, based on the image acquisition time, the electronic device 2000 may update, to the inactive tracking state, tracking states of objects for which the first period has elapsed from the last matching time, among the objects being tracked. For example, when the first period is set to 30 frames, the electronic device 2000 may update, to the inactive tracking state, objects that have not been matched for 30 frames or more from the last matching time, among the objects being tracked.

FIG. 12B illustrates a process of updating a tracking state of an object, according to an embodiment of the disclosure.

In operation S1240, the electronic device 2000 may set, as targets for tracking state update, objects in the inactive tracking state among the objects that have been previously tracked.

In operation S1250, the electronic device 2000 may determine, based on an image acquisition time, whether a second period has elapsed from a time at which each of the objects being tracked was last matched. That is, the electronic device 2000 may determine whether each of the objects being tracked has not been matched for the second period from the last matching time. The second period may be a preset period of time that serves as a reference for the inactive tracking state of an object and termination of object tracking, and may be longer than the first period. For example, the electronic device 2000 may set the second period to 50 frames. The electronic device 2000 may terminate tracking of objects for which the second period has elapsed from the last matching time, among the objects being tracked (S1240). The electronic device 2000 may not terminate tracking of objects for which the second period has not yet elapsed from the last matching time, among the objects being tracked.

In operation S1260, the electronic device 2000 may terminate, based on the image acquisition time, tracking of objects for which the second period has elapsed from the last matching time, among the objects being tracked. When the electronic device 2000 determines to terminate tracking objects, the objects of which tracking has been terminated may not be compared with objects detected in images obtained at a later time.

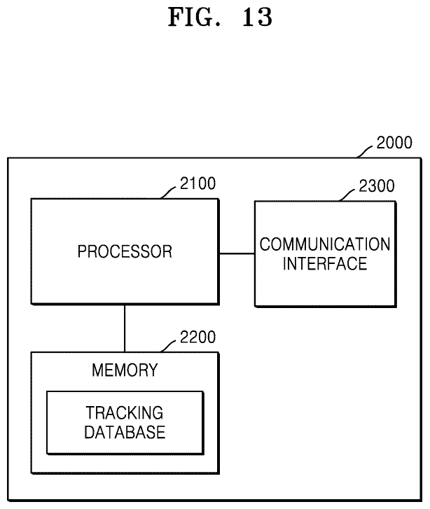

FIG. 13 illustrates a configuration of the electronic device 2000 according to an embodiment of the disclosure.

Referring to FIG. 13, the electronic device 2000 according to an embodiment may include at least one processor 2100, a memory 2200, and a communication interface 2300.

The at least one processor 2100 may control an operation or function performed by the electronic device 2000 by executing instructions stored in the memory 2200 or a programmed software module. The at least one processor 2100 may include hardware components for performing arithmetic, logic, and input/output operations and signal processing.

The at least one processor 2100 may include, for example, at least one of a CPU, a microprocessor, a GPU, application specific integrated circuits (ASICs), DSPs, digital signal processing devices (DSPDs), programmable logic devices (PLDs), field programmable gate arrays (FPGAs), an application processor (AP), a NPU, or an artificial intelligence-specific processor designed with a hardware structure specialized for processing an artificial intelligence model. But, the disclosure is not limited to the above examples. Each processor corresponding to the at least one processor 2100 may be a dedicated processor for performing a predetermined function.

By executing one or more instructions stored in the memory 2200, the at least one processor 2100 may control overall operations of the electronic device 2000 to track at least one object by using an object tracking model.

The memory 2200 may store instructions, data structures, and program code that are readable by the at least one processor 2100. Operations performed by the at least one processor 2100 may be implemented by executing instructions or code of a program stored in the memory 2200.

The memory 2200 may include a flash memory type, hard disk type, multimedia card micro type, or card type memory (for example, SD or XD memory), and may include a non-volatile memory including at least one of read-only memory (ROM), electrically erasable programmable read-only memory (EEPROM), programmable read-only memory (PROM), a magnetic memory, a magnetic disk, or an optical disk, and a volatile memory such as random access memory (RAM) or static random access memory (SRAM).

According to an embodiment, the memory 2200 may store a tracking database so that the electronic device 2000 may track the at least one object.

The communication interface 2300 may perform wired or wireless communication with other devices or networks. The communication interface 2300 may include a communication circuit or communication module that supports at least one of various wired and wireless communication methods. For example, the communication interface 2300 may perform data communication between the electronic device 2000 and other devices by using at least one of data communication methods including, for example, wired LAN, wireless LAN, Wi-Fi, Bluetooth, Zigbee, Wi-Fi direct (WFD), infrared data association (IrDA), Bluetooth low energy (BLE), near field communication (NFC), wireless broadband internet (Wibro), world interoperability for microwave access (WiMAX), shared wireless access protocol (SWAP), wireless gigabit alliance (WiGig), and RF communication.

According to an embodiment, the communication interface 2300 may transmit an image obtained through a camera 2500 to an external server in which an object tracking model is stored. The external server may input the received image into the object tracking model and output the output data. The communication interface 2300 may receive the output data from the external server. In addition, the communication interface 2300 may receive, from an external device, an object tracking model or a training image data set used for training an object tracking model.

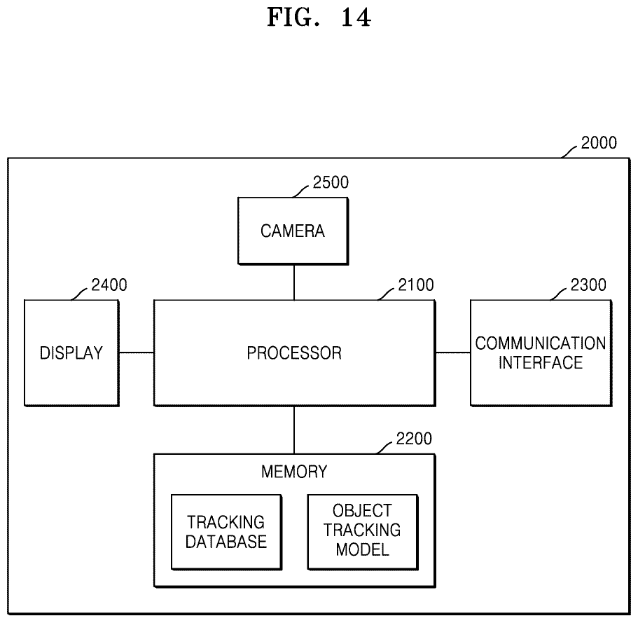

FIG. 14 illustrates a configuration of an electronic device according to an embodiment of the disclosure.

The electronic device 2000 may further include a display 2400 and a camera 2500, in addition to the components shown in FIG. 13.

Descriptions of the at least one processor 2100 and the memory 2200 that overlap the descriptions thereof provided with reference to FIG. 13 are omitted below. The memory 2200 may store a tracking database and an object tracking model. The at least one processor 2100 may load the object tracking model from the memory 2200 and execute the same.

The display 2400 may include an output interface for providing information or an image, and may further include an input interface for receiving an input. The output interface may include a display panel and a controller for controlling the display panel, and may be implemented as various types, such as an organic light-emitting diode (OLED) display, an active-matrix organic light-emitting diode (AM-OLED) display, and a liquid crystal display (LCD). The input interface may receive various types of input from a user, and may include at least one of a touch panel, a keypad, or a pen recognition panel. The display 2400 may be provided in the form of a touch screen that is a combination of a display panel and a touch panel, and may be implemented to be flexible or foldable. According to an embodiment, the display 2400 may output trajectories of objects being tracked in real time.

The camera 2500 is a hardware module for obtaining an image. The camera 2500 may capture an image or video. The camera 2500 may include at least one camera module and, depending on specifications of the electronic device 2000, may support functions such as close-up, depth, telephoto, wide-angle, and ultra-wide-angle.

According to an embodiment of the disclosure, the at least one processor 2100 may obtain an image by executing at least one instruction stored in the memory 2200. By executing the at least one instruction stored in the memory 2200, the at least one processor 2100 may extract, from the image, a feature map for performing a plurality of tasks related to object tracking. By executing the at least one instruction stored in the memory 2200, the at least one processor 2100 may extract, by using the extracted feature map, location information indicating a location of the at least one object, an identification feature for identifying the at least one object, and a body orientation angle at which a body of the at least one object is oriented. By executing the at least one instruction stored in the memory 2200, the at least one processor 2100 may track the at least one object based on the location information, the identification feature, and the body orientation angle of the at least one object.

According to an embodiment, by executing the at least one instruction stored in the memory 2200, the at least one processor 2100 may perform an operation of extracting the feature map and an operation of extracting the location information, the identification feature, and the body orientation angle of the at least one object by using an object tracking model. The object tracking model may be a multi-task artificial intelligence model for performing the plurality of tasks related to object tracking, and may include a backbone network for extracting the feature map, a detection head for extracting the location information of the at least one object, an identification head for extracting the identification feature of the at least one object, and a body orientation head for extracting the body orientation angle of the at least one object. Each of the backbone network and the heads may each include at least one layer.

According to an embodiment, the at least one processor 2100 may identify a class of the at least one object by executing the at least one instruction stored in the memory 2200.

According to an embodiment, by executing the at least one instruction stored in the memory 2200, the at least one processor 2100 may extract, by using the feature map, a heat map indicating a central location of the at least one object on the feature map, a bounding box size of the at least one object, and a center offset for obtaining a central location of the at least one object on the image. By executing the at least one instruction stored in the memory 2200, the at least one processor 2100 may obtain, from the heat map, the central location of the at least one object on the feature map. By executing the at least one instruction stored in the memory 2200, the at least one processor 2100 may extract the location information of the at least one object based on the central location of the at least one object on the feature map, the bounding box size of the at least one object, and the center offset of the at least one object. The heat map may have a heat map score corresponding to each pixel of the heat map, and may have a peak heat map score at the central location of the at least one object on the feature map.

According to an embodiment, by executing the at least one instruction stored in the memory 2200, the at least one processor 2100 may extract identification features by using the feature map. By executing the at least one instruction stored in the memory 2200, the at least one processor 2100 may extract an identification feature of the at least one object from the identification features, based on the central location of the at least one object on the feature map.

According to an embodiment, by executing the at least one instruction, the at least one processor 2100 may extract body orientation embedding vectors by using the feature map. By executing the at least one instruction stored in the memory 2200, the at least one processor 2100 may extract a body orientation embedding vector of the at least one object from the body orientation embedding vectors, based on the central location of the at least one object on the feature map. By executing the at least one instruction stored in the memory 2200, the at least one processor 2100 may extract the body orientation angle of the at least one object based on an element having a maximum value among elements of the body orientation embedding vector of the at least one object. The body orientation embedding vector may include the elements corresponding to respective representative angles of body orientation, and values of the elements may be scores for the respective representative angles of body orientation.

According to an embodiment, by executing the at least one instruction, the at least one processor 2100 may compare, with the identification feature of the at least one object, an identification feature corresponding to the body orientation angle of the at least one object, which is included in an identification feature list of each of objects being tracked. By executing the at least one instruction stored in the memory 2200, the at least one processor 2100 may, when the identification feature list does not include an identification feature corresponding to the body orientation angle of the at least one object, compare, with the identification feature of the at least one object, an identification feature corresponding a representative angle closest to the body orientation angle of the at least one object. By executing the at least one instruction stored in the memory 2200, the at least one processor 2100 may track the at least one object based on a result of the comparison. The identification feature list may include a latest identification feature and at least one identification feature corresponding to each representative angle of body orientation.

According to an embodiment, by executing the at least one instruction, the at least one processor 2100 may, when the at least one object is matched with at least one of the objects being tracked, update, by using the identification feature of the at least one object, a latest identification feature and an identification feature corresponding to the body orientation angle of the at least one object, which are included in an identification feature list of the at least one object.

According to an embodiment, by executing the at least one instruction, the at least one processor 2100 may, when comparison is made with an object that was matched within a preset period from an image acquisition time, among the objects being tracked, compare the object that was matched within the preset period from the image acquisition time with the at least one object, based on the location information of the at least one object and the identification feature of the at least one object, and when comparison is made with an object that was not matched within the preset period from the image acquisition time, among the objects being tracked, compare the object that was not matched within the preset period from the image acquisition time with the at least one object, based on the location information of the at least one object, the identification feature of the at least one object, and the body orientation angle of the at least one object. By executing the at least one instruction, the at least one processor 2100 may track the at least one object based on a result of the comparison.

According to an embodiment of the disclosure, a method of tracking at least one object may include obtaining an image. The method of tracking at least one object may include extracting, from the image, a feature map for performing a plurality of tasks related to object tracking. The method of tracking at least one object may include extracting, by using the extracted feature map, location information indicating a location of the at least one object, an identification feature for identifying the at least one object, and a body orientation angle at which a body of the at least one object is oriented. The method of tracking at least one object may include tracking the at least one object based on the location information, the identification feature, and the body orientation angle of the at least one object.

According to an embodiment, in the method of tracking at least one object, the extracting of the feature map and the extracting of the location information, the identification feature, and the body orientation angle of the at least one object may be performed through an object tracking model. The object tracking model may be a multi-task artificial intelligence model for performing the plurality of tasks related to object tracking, and may include a backbone network for extracting the feature map, a detection head for extracting the location information of the at least one object, an identification head for extracting the identification feature of the at least one object, and a body orientation head for extracting the body orientation angle of the at least one object. Each of the backbone network and the heads may each include at least one layer.

According to an embodiment, in the method of tracking at least one object, the object tracking model may be trained with an image data set including an annotation for a class indicating a type of the object, an annotation for an ID of the object, an annotation for bounding box information indicating a location and size of the object as a rectangle, an annotation for segmentation information indicating a boundary of the object, and an annotation for a body orientation angle at which a body of the object is oriented.

According to an embodiment, in the method of tracking at least one object, the extracting of the location information of the at least one object by using the feature map may include identifying a class of the at least one object.

According to an embodiment, in the method of tracking at least one object, the extracting of the location information of the at least one object by using the feature map may include extracting, by using the feature map, a heat map indicating a central location of the at least one object on the feature map, a bounding box size of the at least one object, and a center offset for obtaining a central location of the at least one object on the image. The extracting of the location information of the at least one object by using the feature map may include obtaining, from the heat map, the central location of the at least one object on the feature map. The extracting of the location information of the at least one object by using the feature map may include extracting the location information of the at least one object based on the central location of the at least one object on the feature map, the bounding box size of the at least one object, and the center offset of the at least one object. The heat map may have a heat map score corresponding to each pixel of the heat map, and may have a peak heat map score at the central location of the at least one object on the feature map.

According to an embodiment, in the method of tracking at least one object, the extracting of the identification feature of the at least one object by using the feature map may include extracting identification features by using the feature map. The extracting of the identification feature of the at least one object by using the feature map may include extracting the identification feature of the at least one object from the identification features, based on the central location of the at least one object on the feature map.

According to an embodiment, in the method of tracking at least one object, the extracting of the body orientation angle of the at least one object by using the feature map may include extracting body orientation embedding vectors by using the feature map. The extracting of the body orientation angle of the at least one object may include extracting a body orientation embedding vector of the at least one object from the body orientation embedding vectors, based on the central location of the at least one object on the feature map. The extracting of the body orientation angle of the at least one object may include extracting the body orientation angle of the at least one object based on an element having a maximum value among elements of the body orientation embedding vector of the at least one object. The body orientation embedding vector may include the elements corresponding to respective representative angles of body orientation, and values of the elements may be scores for the respective representative angles of body orientation.

According to an embodiment, in the method of tracking at least one object, the tracking of the at least one object based on the location information of the at least one object, the identification feature of the at least one object, and the body orientation angle of the at least one object may include determining whether an identification feature corresponding to the body orientation angle of the at least one object exists in an identification feature list of each of objects being tracked.

The tracking of the at least one object based on the location information of the at least one object, the identification feature of the at least one object, and the body orientation angle of the at least one object may include, when the identification feature list includes an identification feature corresponding to the body orientation angle of the at least one object, comparing, with the identification feature of the at least one object, the identification feature corresponding to the body orientation angle of the at least one object, which is included in the identification feature list, and when the identification feature list does not include an identification feature corresponding to the body orientation angle of the at least one object, comparing, with the identification feature of the at least one object, an identification feature corresponding a representative angle closest to the body orientation angle of the at least one object.

The tracking of the at least one object based on the location information of the at least one object, the identification feature of the at least one object, and the body orientation angle of the at least one object may include tracking the at least one object based on a result of the comparison. The identification feature list may include a latest identification feature of the object and at least one identification feature of the object corresponding to each representative angle of body orientation.

According to an embodiment, the method of tracking at least one object may include, when the at least one object is matched with at least one of the objects being tracked, updating, by using the identification feature of the at least one object, a latest identification feature and an identification feature corresponding to the body orientation angle of the at least one object, which are included in an identification feature list of the at least one object.

According to an embodiment, in the method of tracking at least one object, the tracking of the at least one object based on the location information of the at least one object, the identification feature of the at least one object, and the body orientation angle of the at least one object may include, when comparison is made with an object that was matched within a preset period from an image acquisition time, among the objects being tracked, comparing the object that was matched within the preset period from the image acquisition time with the at least one object, based on the location information of the at least one object and the identification feature of the at least one object, and when comparison is made with an object that was not matched within the preset period from the image acquisition time, among the objects being tracked, comparing the object that was not matched within the preset period from the image acquisition time with the at least one object, based on the location information of the at least one object, the identification feature of the at least one object, and the body orientation angle of the at least one object.

The tracking of the at least one object based on the location information of the at least one object, the identification feature of the at least one object, and the body orientation angle of the at least one object may include tracking the at least one object based on a result of the comparison.

A machine-readable storage medium may be provided in the form of a non-transitory storage medium. Here, the ‘non-transitory storage medium’ is or corresponds to a tangible device and does not contain a signal (for example, electromagnetic waves). This term does not distinguish a case where data is stored in the storage medium semi-permanently and a case where the data is stored in the storage medium temporarily. For example, the ‘non-transitory storage medium’ may include a buffer in which data is temporarily stored.

According to an embodiment, a method according to one or more embodiments disclosed in the present specification may be provided by being included in a computer program product. The computer program product may be a commercial product that may be traded between a seller and a buyer. The computer program product may be distributed in the form of a machine-readable storage medium (for example, a compact disc read-only memory (CD-ROM)), through an application store, directly between two user devices (for example, smart phones), or online (for example, downloaded or uploaded). In the case of online distribution, at least a part of the computer program product (for example, a downloadable application) may be at least temporarily generated or temporarily stored in a machine-readable storage medium, such as a server of a manufacturer, a server of an application store, or a memory of a relay server.

What is claimed is:

1. A method of tracking at least one object, the method comprising:
obtaining an image;
extracting, from the image, a feature map for performing a plurality of tasks related to object tracking;
extracting, by using the extracted feature map, location information indicating a location of the at least one object, an identification feature for identifying the at least one object, and a body orientation angle at which a body of the at least one object is oriented; and
tracking the at least one object, based on the location information, the identification feature, and the body orientation angle of the at least one object.

2. The method of claim 1, further comprising performing, by using an object tracking model, the extracting of the feature map and the extracting of the location information, the identification feature, and the body orientation angle,
wherein the object tracking model is a multi-task artificial intelligence model configured to perform the plurality of tasks related to object tracking,
wherein the object tracking model includes:
a backbone network configured to extract the feature map,
a detection head configured to extract the location information of the at least one object,
an identification head configured to extract the identification feature of the at least one object, and
a body orientation head configured to extract the body orientation angle of the at least one object, and
wherein each of the backbone network, the detection head, the identification head, and the body orientation head includes at least one layer.

3. The method of claim 1, wherein the extracting of the location information, further comprises:
extracting, by using the feature map, a heat map indicating a central location of the at least one object on the feature map, a bounding box size of the at least one object, and a center offset for obtaining a central location of the at least one object on the image;
obtaining, from the heat map, the central location of the at least one object on the feature map; and
extracting the location information of the at least one object, based on the central location of the at least one object on the feature map, the bounding box size of the at least one object, and the center offset of the at least one object,
wherein the heat map includes a heat map score corresponding to each pixel of the heat map, and
wherein the heat map includes a peak heat map score at the central location of the at least one object on the feature map.

4. The method of claim 1, wherein the extracting of the identification feature, comprises:
extracting identification features by using the feature map; and
extracting the identification feature of the at least one object from the identification features, based on the central location of the at least one object on the feature map.

5. The method of claim 1, wherein the extracting of the body orientation angle, comprises:
extracting body orientation embedding vectors by using the feature map;
extracting a body orientation embedding vector of the at least one object from the body orientation embedding vectors, based on the central location of the at least one object on the feature map; and
extracting the body orientation angle of the at least one object, based on an element having a maximum value among elements of the body orientation embedding vector of the at least one object,
wherein the body orientation embedding vector includes the elements corresponding to respective representative angles of body orientation, and
wherein values of the elements are scores for the respective representative angles of body orientation.

6. The method of claim 1, wherein the tracking of the at least one object, comprises:
determining whether an identification feature corresponding to the body orientation angle of the at least one object exists in an identification feature list of each of objects being tracked;
when the identification feature list includes an identification feature corresponding to the body orientation angle of the at least one object, comparing, with the identification feature of the at least one object, the identification feature corresponding to the body orientation angle of the at least one object, which is included in the identification feature list,
when the identification feature list does not include an identification feature corresponding to the body orientation angle of the at least one object, comparing, with the identification feature of the at least one object, an identification feature corresponding a representative angle closest to the body orientation angle of the at least one object, which is included in the identification feature list; and
tracking the at least one object, based on a result of the comparing of the identification feature corresponding to the body orientation angle of the at least one object with the identification feature of the at least one object, and
wherein the identification feature list includes a latest identification feature of the object and at least one identification feature of the object corresponding to each representative angle of body orientation.

7. The method of claim 6, further comprising, when the at least one object is matched with at least one of the objects being tracked, updating, by using the identification feature of the at least one object, a latest identification feature and an identification feature corresponding to the body orientation angle of the at least one object, which are included in an identification feature list of the at least one object.

8. An electronic device configured to track at least one object, the electronic device comprising:
a communication interface;
memory storing at least one instruction; and
at least one processor operatively connected with the memory,
wherein the at least one processor is configured to execute the at least one instruction to:
obtain an image;
extract, from the image, a feature map for performing a plurality of tasks related to object tracking;
extract, by using the extracted feature map, location information indicating a location of the at least one object, an identification feature for identifying the at least one object, and a body orientation angle at which a body of the at least one object is oriented; and
track the at least one object, based on the location information, the identification feature, and the body orientation angle of the at least one object.

9. The electronic device of claim 8, wherein the at least one processor is configured to execute the at least one instruction to perform, by using an object tracking model, a first operation of extracting the feature map and a second operation of extracting the location information, the identification feature, and the body orientation angle,
wherein the object tracking model is a multi-task artificial intelligence model configured to perform the plurality of tasks related to object tracking,
wherein the object tracking model comprises:
a backbone network configured to extract the feature map,
a detection head configured to extract the location information of the at least one object,
an identification head configured to extract the identification feature of the at least one object, and
a body orientation head configured to extract the body orientation angle of the at least one object, and
wherein each of the backbone network, the detection head, the identification head, and the body orientation head includes at least one layer.

10. The electronic device of claim 8, wherein the at least one processor is further configured to execute the at least one instruction to:
extract, by using the feature map, a heat map indicating a central location of the at least one object on the feature map, a bounding box size of the at least one object, and a center offset for obtaining a central location of the at least one object on the image;
obtain, from the heat map, the central location of the at least one object on the feature map; and
extract the location information of the at least one object based on the central location of the at least one object on the feature map, the bounding box size of the at least one object, and the center offset of the at least one object,
wherein the heat map comprises a heat map score corresponding to each pixel of the heat map, and
wherein the heat map comprises a peak heat map score at the central location of the at least one object on the feature map.

11. The electronic device of claim 8, wherein the at least one processor is further configured to execute the at least one instruction to:
extract identification features by using the feature map, and
extract the identification feature of the at least one object from the identification features, based on the central location of the at least one object on the feature map.

12. The electronic device of claim 8, wherein the at least one processor is further configured to execute the at least one instruction to:
extract body orientation embedding vectors by using the feature map;
extract a body orientation embedding vector of the at least one object from the body orientation embedding vectors, based on the central location of the at least one object on the feature map; and
extract the body orientation angle of the at least one object based on an element having a maximum value among elements of the body orientation embedding vector of the at least one object,
wherein the body orientation embedding vector comprises the elements corresponding to respective representative angles of body orientation, and
wherein values of the elements are scores for the respective representative angles of body orientation.

13. The electronic device of claim 8, wherein the at least one processor is further configured to execute the at least one instruction to:
determine whether an identification feature corresponding to the body orientation angle of the at least one object exists in an identification feature list of each of objects being tracked;
when the identification feature list comprises an identification feature corresponding to the body orientation angle of the at least one object, compare, with the identification feature of the at least one object, the identification feature corresponding to the body orientation angle of the at least one object, which is included in the identification feature list;
when the identification feature list does not comprise an identification feature corresponding to the body orientation angle of the at least one object, compare, with the identification feature of the at least one object, an identification feature corresponding a representative angle closest to the body orientation angle of the at least one object; and
track the at least one object based on a result of a comparison of the identification feature corresponding to the body orientation angle of the at least one object and the identification feature of the at least one object, and
wherein the identification feature list comprises a latest identification feature and at least one identification feature corresponding to each representative angle of body orientation.

14. The electronic device of claim 8, wherein the at least one processor 2100 is further configured to execute the at least one instruction to, when the at least one object is matched with at least one of the objects being tracked, update, by using the identification feature of the at least one object, a latest identification feature and an identification feature corresponding to the body orientation angle of the at least one object, which are included in an identification feature list of the at least one object.

15. A non-transitory computer-readable recording medium having recorded thereon a program for performing, on a computer, a method of tracking at least one object, comprising:
obtaining an image;
extracting, from the image, a feature map for performing a plurality of tasks related to object tracking;
extracting, by using the extracted feature map, location information indicating a location of the at least one object, an identification feature for identifying the at least one object, and a body orientation angle at which a body of the at least one object is oriented; and
tracking the at least one object, based on the location information, the identification feature, and the body orientation angle of the at least one object.
